(19) United States
(12) Patent Application Publication
(10) Pub. No.: US 2015/0373408 A1
(43) Pub. Date: Dec. 24, 2015

(54) COMMAND SOURCE USER IDENTIFICATION

(71) Applicant: Comcast Cable Communications, LLC, Philadelphia, PA (US)

(72) Inventors: Bryan Yurasits, Levittown, PA (US); Maurice Gaston, Philadelphia, PA (US)

(21) Appl. No.: 14/313,518

(22) Filed: Jun. 24, 2014

(51) Int. Cl. H04N 21/45; H04N 21/466; G06K 9/00

(52) U.S. Cl. CPC H04N 21/4532; G06K 9/00288; G06K 9/00268; H04N 21/4667

(57) ABSTRACT

A sensor-based system may detect users in a space who are consuming content, such as watching a television program. The system may capture images of the users, recognize features such as their faces and bodies to identify them, and capture a control signal, such as an infrared flash from a remote control device. The system may determine which user was manipulating the remote control, and may then associate the remote control command with the identified user. In this manner, users may be provided with a customized interactive experience.

### BACKGROUND

Watching television is becoming more complicated, as modern systems offer features such as much more second screen experiences, interactive viewing sessions, and user customization. User customization may allow the viewer to quickly find programs of interest by, for example, providing a favorite channel list tailored to the user's preferences. Customization, however, is possible or can be fully implemented if the system knows who is watching. Identifying viewers can be problematic, for example, if there are many users in the room or if there is movement among users. To better provide a user-tailored experience, there remains a need to be able to identify users.

### SUMMARY

The following summary is for illustrative purposes only, and is not intended to limit or constrain the detailed description.

Some features herein relate to determining which user in a room of users is controlling a content consumption experience. For example, if there are two people in the room watching a video program, and one of them changes the channel, asks to see an electronic program guide, or otherwise interacts with content, features herein may assist in determining which user is requesting the change or interaction, so that the ensuing response may be appropriately tailored or customized to that user's preferences.

In some embodiments, a content delivery system may include one or more sensors (e.g., cameras or other signal sensors) positioned to view or sense the users as they watch a video display (e.g., a television). The sensors may capture data which may be converted into an image related to the users such as their bodies (e.g., faces, shoulders, arms, hands, etc.), and may also optionally capture an image of a command being transmitted from a wireless remote control. For example, infrared remote controls may be variously configured such as to transmit their commands through pulses of infrared light that are sent by the remote control and detected by the infrared receiver of a device associated with a content consumption device (e.g., a television, set-top box (STB), digital video recorder (DVR), gateway, etc.). In some embodiments, the sensors may include an infrared camera, which may also detect the remote control's infrared signal, e.g., as a flash of light in the image.

A computing device may be variously configured such as to process the data captured by the sensors or images (e.g., combining images from multiple cameras, such as an infrared camera and a visible light camera) to determine which user is manipulating the remote control to send the remote control command. In some embodiments, this may be done by comparing distances, in the image, between the flash of light from the remote control and the detected faces or other features related to the users or by comparing the remote control signal flash to personal space maps of the users. Different algorithms may variously be used to associate the control device or signal with the user such as mapping the user's outline, associating appendages (e.g., arms) with users, and/or using more simplistic algorithms such as using the face closest to the flash. Using suitable algorithms, it may be determined which user entered the remote control command. The identity of the user may be variously determined such as by associating a user with a particular control device (e.g., smart phone) and/or by associating a face e.g., through facial recognition software with a particular user. The response to the command may then be provided in accordance with the personal preferences of the identified user.

In some embodiments, the computing device and sensors may be able to detect other body parts of the users or spatial relationships between body parts of users, such as their hands, arms, shoulders, necks, eyes, etc. With the identification of the body parts, the computing device may be able to determine whose hand was holding the remote control when the command was sent. In such embodiments, even if another user's face was located closer (in the field of view) to the remote control than a primary user, the primary user may still be identified as the one sending the command, if the primary user's hand can be identified as the one holding the remote control. Similarly, the system may determine that the other user's hands were both away from the remote control, and may conclude that the other user was not the one to send the remote control command.

In some embodiments, the personal space map of a user may be constructed based on the distance of each point from a body part of a user such as the hands, arms, shoulders, neck, or eyes of the user. The personal space map may also be constructed based on a determination of the probability that a remote control signal originating from a particular location is initiated by that user.

The summary here is not an exhaustive listing of the novel features described herein, and are not limiting of the claims. These and other features are described in greater detail below.

### BRIEF DESCRIPTION OF THE DRAWINGS

These and other features, aspects, and advantages of the present disclosure will become better understood with regard to the following description, claims, and drawings. The present disclosure is illustrated by way of example, and not limited by, the accompanying figures in which like numerals indicate similar elements.

FIG. 1 illustrates an example communication network on which various features described herein may be used.

FIG. 2 illustrates an example computing device that can be used to implement any of the methods, servers, entities, and computing devices described herein.

FIG. 3 illustrates an example image that may be captured using one or more sensors.

FIGS. 4a-c illustrate examples of one or more of facial and body part recognition, remote control signal detection, and distance and other sensor measurements in accordance with some aspects of the disclosure.

FIG. 5 illustrates an example algorithm and method to implement one or more features described herein.

FIG. 6 illustrates an example captured image data overlaid with personal space maps of users in accordance with one or more aspects of the disclosure.

FIG. 7 illustrates an example algorithm and method for building a personal space map in accordance with one or more aspects of the disclosure.

FIG. 8 illustrates an example algorithm and method of identifying a user as an active user in accordance with one or more aspects of the disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

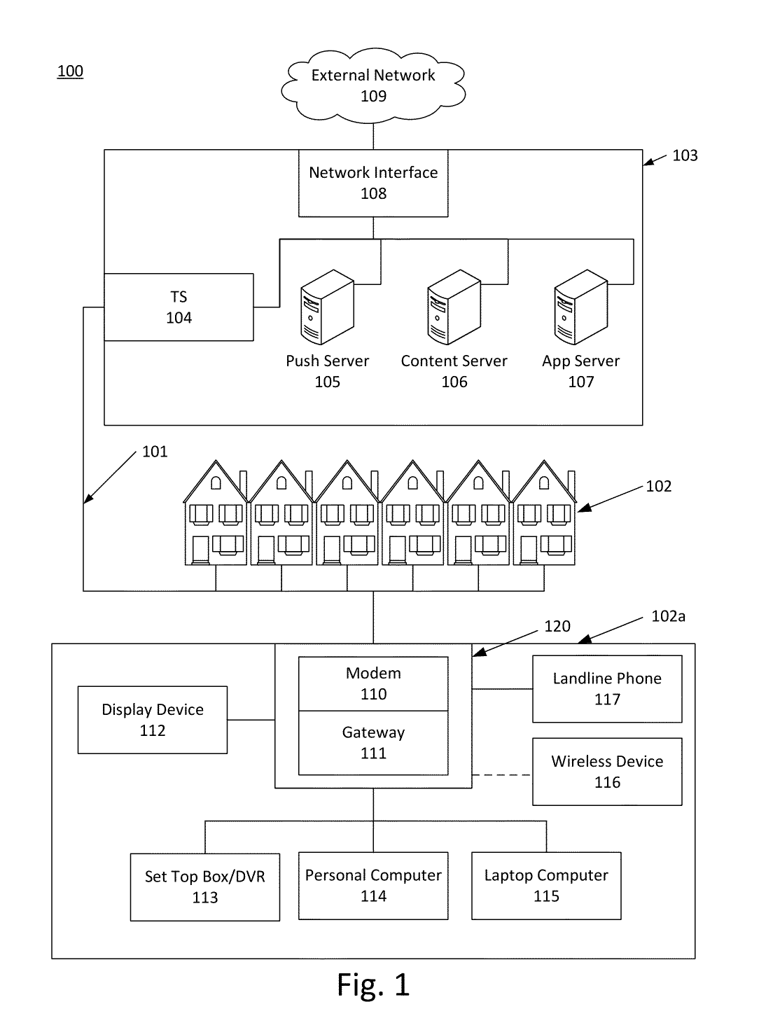

FIG. 1 illustrates an example communication network 100 on which many of the various features described herein may be implemented. Network 100 may be any type of information distribution network, such as satellite, telephone, cellular, wireless, etc. One example may be an optical fiber network, a coaxial cable network, or a hybrid fiber/coax distribution network. Such networks 100 use a series of interconnected communication links 101 (e.g., coaxial cables, optical fibers, wireless, etc.) to connect multiple premises 102 (e.g., businesses, homes, consumer dwellings, etc.) to a local office or headend 103. The local office 103 may transmit downstream information signals onto the links 101, and each premises 102 may have a receiver used to receive and process those signals.

There may be one link 101 originating from the local office 103, and it may be split a number of times to distribute the signal to various premises 102 in the vicinity (which may be many miles) of the local office 103. The links 101 may include components not illustrated, such as splitters, filters, amplifiers, etc. to help convey the signal clearly, but in general each split introduces a bit of signal degradation. Portions of the links 101 may also be implemented with fiber-optic cable, while other portions may be implemented with coaxial cable, other lines, or wireless communication paths.

The local office 103 may include an interface, such as a termination system (TS) 104. More specifically, the interface 104 may be a cable modem termination system (CMTS), which may be a computing device configured to manage communications between devices on the network of links 101 and backend devices such as servers 105-107 (to be discussed further below). The interface 104 may be as specified in a standard, such as the Data Over Cable Service Interface Specification (DOCSIS) standard, published by Cable Television Laboratories, Inc. (a.k.a. CableLabs), or it may be a similar or modified device instead. The interface 104 may be configured to place data on one or more downstream frequencies to be received by modems at the various premises 102, and to receive upstream communications from those modems on one or more upstream frequencies.

The local office 103 may also include one or more network interfaces 108, which can permit the local office 103 to communicate with various other external networks 109. These networks 109 may include, for example, networks of Internet devices, telephone networks, cellular telephone networks, fiber optic networks, local wireless networks (e.g., WiMAX), satellite networks, and any other desired network, and the network interface 108 may include the corresponding circuitry needed to communicate on the external networks 109, and to other devices on the network such as a cellular telephone network and its corresponding cell phones.

As noted above, the local office 103 may include a variety of servers 105-107 that may be configured to perform various functions. For example, the local office 103 may include a push notification server 105. The push notification server 105 may generate push notifications to deliver data and/or commands to the various premises 102 in the network (or more specifically, to the devices in the premises 102 that are configured to detect such notifications). The local office 103 may also include a content server 106. The content server 106 may be one or more computing devices that are configured to provide content to users at their premises. This content may be, for example, video on demand movies, television programs, songs, text listings, etc. The content server 106 may include software to validate user identities and entitlements, to locate and retrieve requested content, to encrypt the content, and to initiate delivery (e.g., streaming) of the content to the requesting user(s) and/or device(s).

The local office 103 may also include one or more application servers 107. An application server 107 may be a computing device configured to offer any desired service, and may run various languages and operating systems (e.g., servlets and JSP pages running on Tomcat/MySQL, OSX, BSD, Ubuntu, Redhat, HTML5, JavaScript, AJAX and COMET). For example, an application server may be responsible for collecting television program listings information and generating a data download for electronic program guide listings. Another application server may be responsible for monitoring user viewing habits and collecting that information for use in selecting advertisements. Yet another application server may be responsible for formatting and inserting advertisements in a video stream being transmitted to the premises 102. Although shown separately, one of ordinary skill in the art will appreciate that the push server 105, content server 106, and application server 107 may be combined. Further, here the push server 105, content server 106, and application server 107 are shown generally, and it will be understood that they may each contain memory storing computer executable instructions to cause a processor to perform steps described herein and/or memory for storing data.

An example premises 102a, such as a home, may include an interface 120. The interface 120 can include any communication circuitry needed to allow a device to communicate on one or more links 101 with other devices in the network. For example, the interface 120 may include a modem 110, which may include transmitters and receivers used to communicate on the links 101 and with the local office 103. The modem 110 may be, for example, a coaxial cable modem (for coaxial cable lines 101), a fiber interface node (for fiber optic lines 101), twisted-pair telephone modem, cellular telephone transceiver, satellite transceiver, local wi-fi router or access point, or any other desired modem device. Also, although only one modem is shown in FIG. 1, a plurality of modems operating in parallel may be implemented within the interface 120. Further, the interface 120 may include a gateway interface device 111. The modem 110 may be connected to, or be a part of, the gateway interface device 111. The gateway interface device 111 may be a computing device that communicates with the modem(s) 110 to allow one or more other devices in the premises 102a, to communicate with the local office 103 and other devices beyond the local office 103. The gateway 111 may be a set-top box (STB), digital video recorder (DVR), computer server, or any other desired computing device. The gateway 111 may also include (not shown) local network interfaces to provide communication signals to requesting entities/devices in the premises 102a, such as display devices 112 (e.g., televisions), additional STBs or DVRs 113, personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA), etc.), landline phones 117 (e.g. Voice over Internet Protocol—VoIP phones), and any other desired devices. Examples of the local network interfaces include Multimedia Over Coax Alliance (MoCA) interfaces, Ethernet interfaces, universal serial bus (USB) interfaces, wireless interfaces (e.g., IEEE 802.11, IEEE 802.15), analog twisted pair interfaces, Bluetooth interfaces, and others.

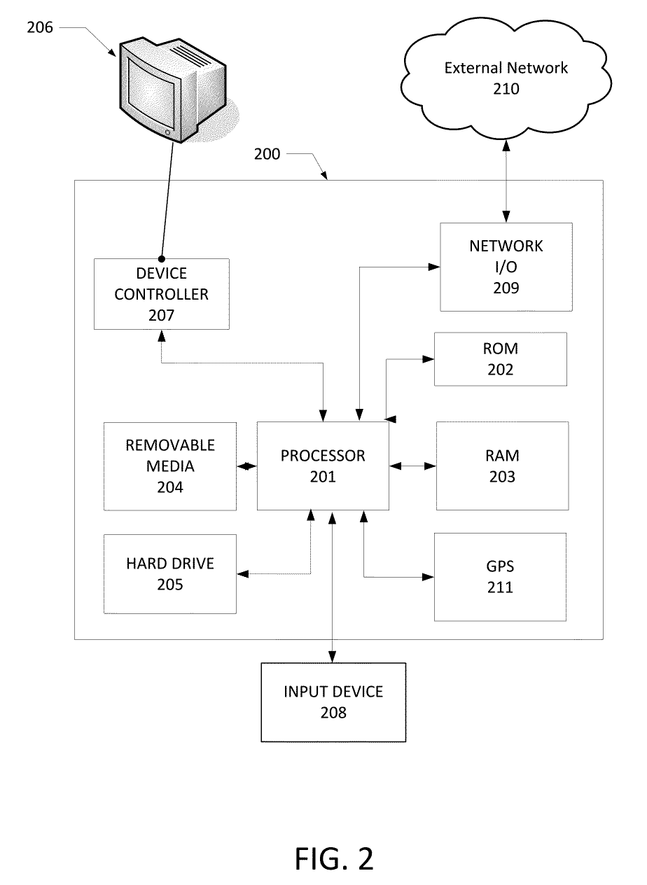

FIG. 2 illustrates general hardware elements that can be used to implement any of the various computing devices discussed herein. The computing device 200 may include one or more processors 201, which may execute instructions of a computer program to perform any of the features described herein. The instructions may be stored in any type of computer-readable medium or memory, to configure the operation of the processor 201. For example, instructions may be stored in a read-only memory (ROM) 202, random access memory (RAM) 203, removable media 204, such as a Universal Serial Bus (USB) drive, compact disk (CD) or digital versatile disk (DVD), floppy disk drive, or any other desired storage medium. Instructions may also be stored in an attached (or internal) hard drive 205. The computing device 200 may include one or more output devices, such as a display 206 (e.g., an external television), and may include one or more output device controllers 207, such as a video processor. There may also be one or more user input devices 208, such as a remote control, keyboard, mouse, touch screen, microphone, etc. The computing device 200 may also include one or more network interfaces, such as a network input/output (I/O) circuit 209 (e.g., a network card) to communicate with an external network 210. The network input/output circuit 209 may be a wired interface, wireless interface, or a combination of the two. In some embodiments, the network input/output circuit 209 may include a modem (e.g., a cable modem), and the external network 210 may include the communication links 101 discussed above, the external network 109, an in-home network, a provider's wireless, coaxial, fiber, or hybrid fiber/coaxial distribution system (e.g., a DOCSIS network), or any other desired network. Additionally, the device may include a location-detecting device, such as a global positioning system (GPS) microprocessor 211, which can be configured to receive and process global positioning signals and determine, with possible assistance from an external server and antenna, a geographic position of the device.

The FIG. 2 example is a hardware configuration, although the illustrated components may be implemented as software as well. Modifications may be made to add, remove, combine, divide, etc. components of the computing device 200 as desired. Additionally, the components illustrated may be implemented using basic computing devices and components, and the same components (e.g., processor 201, ROM storage 202, display 206, etc.) may be used to implement any of the other computing devices and components described herein. For example, the various components herein may be implemented using computing devices having components such as a processor executing computer-executable instructions stored on a computer-readable medium, as illustrated in FIG. 2. Some or all of the entities described herein may be software based, and may co-exist in a common physical platform (e.g., a requesting entity can be a separate software process and program from a dependent entity, both of which may be executed as software on a common computing device).

One or more aspects of the disclosure may be embodied in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the disclosure, and such data structures are contemplated within the scope of computer executable instructions and computer-usable data described herein.

To provide a better user experience, it may be desirable for a system such as a content delivery system or device such as a content consumption device to be able to identify which user(s) are in the room and customize settings, profiles, or preferences to be specific to the user(s) such as an active user or a group of identified users. Profiles, settings, or preferences may be customized based on the user who is in control of a remote control device or the group of users present in the viewing area or field of view of an image device. Determination of the user in control of the remote control device may be ascertained from analysis of an image captured at the time of a signal transmission from the remote control device. A computing device may be used to process a captured image and determine an associated user for the control signal. A user may be associated with the remote control device based on relative positions of the user and the remote control device, and the user in control of the remote control device may be identified as the active user.

An image may be a graphical or visual representation of a scene or environment based on data captured by one or more imaging devices such as sensors or cameras. For example, an image may be an image captured by a camera detecting electromagnetic radiation such as different wavelengths of light including infrared, ultraviolet, and visible light. As another example, an image may be constructed from data of a scene or environment captured using sensors or cameras detecting electromagnetic waves such as radio signals (e.g., Wi-Fi) or sound waves such as ultrasonic waves.

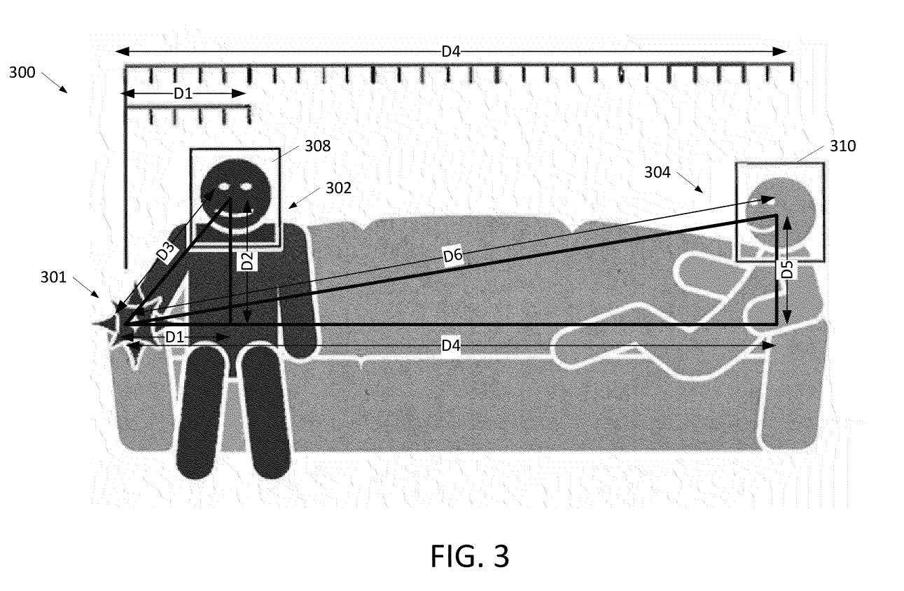

FIG. 3 illustrates an exemplary two-dimensional (2D) image which may be captured of a viewing area using one or more imaging devices such as one or more cameras or sensors (e.g., in some embodiments, the captured image may be a combined image from cameras configured to detect different wavelengths of light (e.g., infrared, ultraviolet, visible) or electromagnetic radiation). The image of a viewing area may also be captured using one or more imaging devices capable of capturing a three-dimensional (3D) image or 3D information of the users in the viewing area. For example, one or more imaging devices may be used to capture information such as the depth of objects in the room to determine 3D structures or objects in space such as bodies or body parts.

The viewing scenario or scene shown in FIG. 3 is that of two users 302, 304 sitting on a couch with user 302 holding the remote from which a remote control signal 301 is transmitted such as an infrared (IR) signal. To the camera, the remote control signal 301 may appear as a flash of light. To determine which users 302, 304 may be in the area and the location in the area of the users, facial recognition of the users 302, 304 in the captured image may be performed using a computing device. The system may determine which user initiated the remote control signal 301 transmitted from the remote control device to customize the user's experience, and the settings and profiles may be customized to the user who initiated transmission of the signal 301. For example, the user may have pressed a “favorites” button requesting a listing of favorite channels. Since each user may have different favorite channels, a system or a device may determine which user initiated the remote control signal 301 and display the user's personal list of favorite channels.

There are a variety of ways to determine which user initiated the remote control signal 301. One example is to determine proximity or the distance between the location of the remote control signal 301 and a user and associate initiation of the signal 301 with the closest user. Another example is to determine which user is holding or in possession of the remote control device. The system may also calculate the likelihood that a particular user is in control of the remote control device based on varying distances from the user in various directions which may be presented in the form of a personal space map.

The distance between the originating location of the remote control signal 301 and the users 302, 304 may be determined from any point on the users 302, 304 such as the faces 308, 310 of the users 302, 304. In the example shown in FIG. 3, the distance being determined may be a horizontal distance between horizontal positions of the signal 301 and the faces 308, 310 as indicated by the guide 312 shown above the users 302, 304. Because the horizontal distance between the face 308 of user 302 and the signal 301 is shorter than the distance between the face 310 of user 304 and the remote control signal 301, the system may associate the remote control signal 301 with user 302.

According to another aspect, the remote control signal 301 and thereby the remote control may be associated with the user with the shortest hypotenuse distance from the remote control signal 301. For example, the horizontal distance and vertical distance of a point on the user's face from the remote control signal 301 may be used to calculate the hypotenuse. As shown in illustrative FIG. 3, the hypotenuse may be D3 calculated from the horizontal distance D1 and the vertical distance D2 between the remote control signal 301 and the user's face such that D3=\sqrt{D1²+D2²}. The hypotenuse D6 of the second user can be similarly calculated using horizontal distance D4 and vertical distance D5 from the remote control signal 301. The hypotenuse distances D3, D6 can be compared, and the remote control signal 301 may be associated with the user having the shortest or smallest hypotenuse distance.

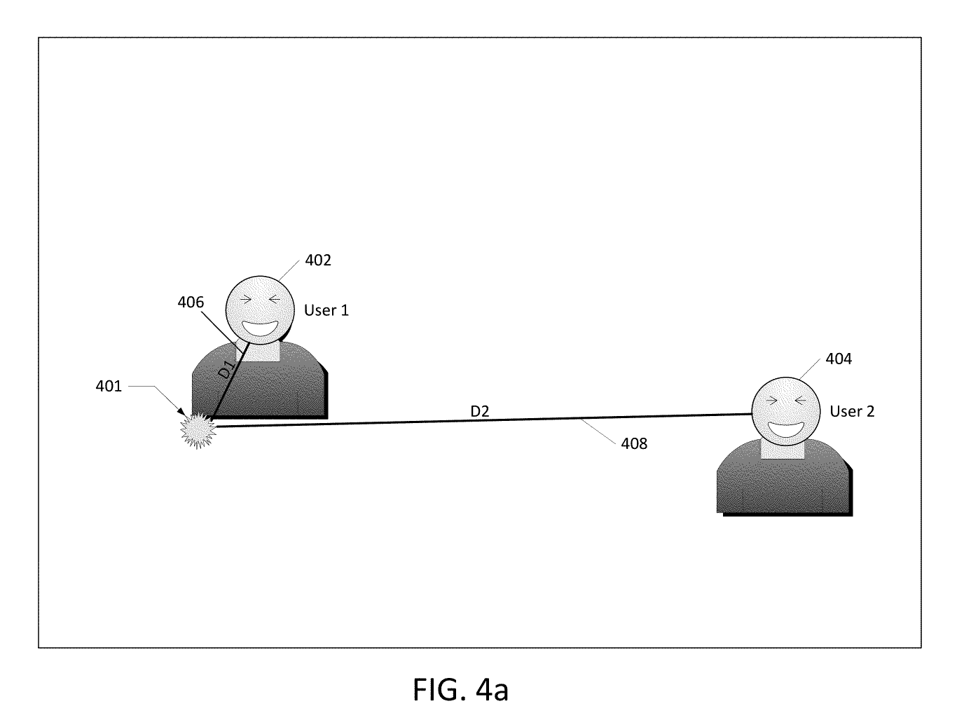

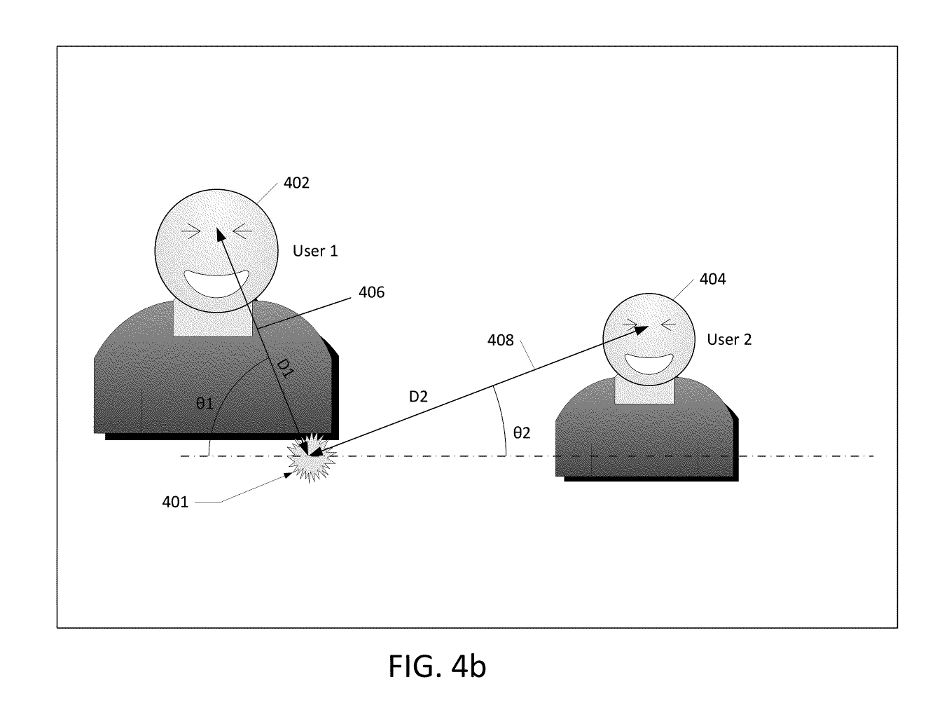

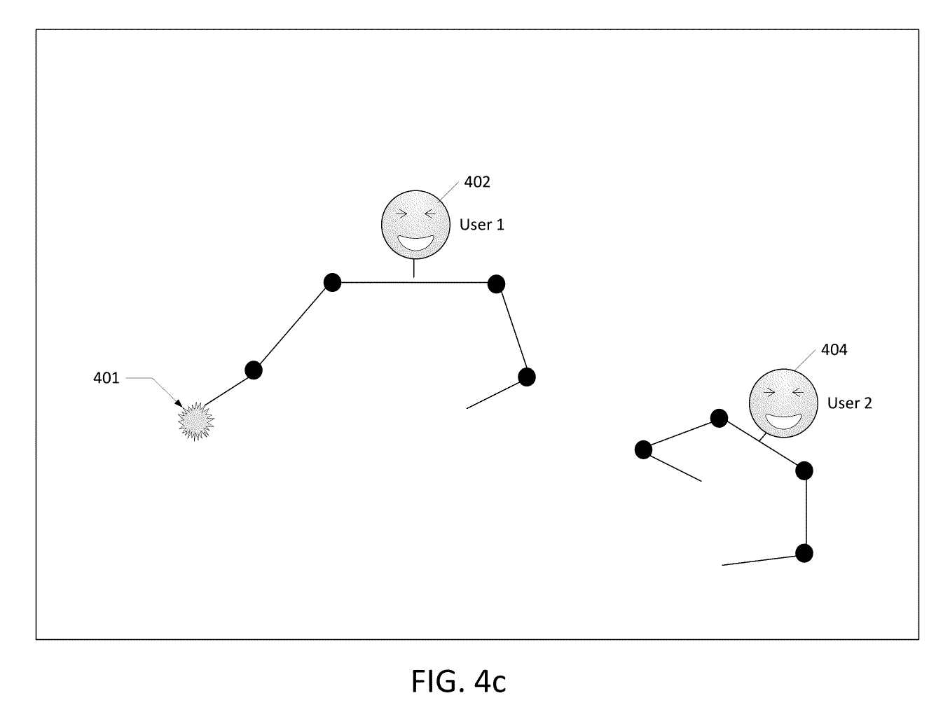

FIGS. 4a-c show additional examples of how a transmitted remote control signal may be associated with a user according to some aspects described herein.

FIG. 4a shows an example of associating a transmitted remote control signal with a user based on a distance determination that is not limited to positions along a horizontal line. The distance between the originating location of remote control signal 401 and the face of the first user 402 is distance D1, and the distance between the signal 401 and the face of the second user 404 is distance D2. In this example, the distances may be the shortest absolute distance between the users 402, 404 and the remote control signal 401 such as a straight line in two dimensions between the face of the user and the remote control signal 401 as illustrated in FIG. 4a. The transmitted remote control signal may be associated with the user having the shortest or smallest distance.

FIG. 4b shows another example of associating a remote control signal 401 with a user by taking into account the distances D1, D2 between the eyes of the users 402, 404 and the remote control signal 401 shown as lines 406, 408 and an angle formed by lines 406, 408. The angle may be measured as, for example, the angle between a horizontal axis 410 through the remote control signal 401 and the lines 406, 408. Angle θ1 may be the angle between the line 406 and the horizontal axis 410, and angle θ2 may be the angle between the line 408 and the horizontal axis 410. Based on a combination of the distance and angle associated with a user, the device can determine which user may be associated with the remote control signal. Since users may typically hold a remote closer to their bodies or in front of them and below their eyes, a larger angle and a shorter distance for a particular user may indicate that the remote control signal should be associated with that user. The device may associate the remote control signal with the user that has the larger angle and the shorter distance as compared to the corresponding angle and distance of other users. Additional considerations may be used in situations where one user has a larger angle and another user has a shorter distance. For example, additional methods to identify the user of the remote control described herein may be used such as determining which user appears to be physically connected to the remote control signal or using personal space maps as will be described later herein.

FIG. 4c shows an example of associating a remote control signal 401 with a user based on determining whether the user has an appendage connection such as appearing to be physically linked or connected to the transmitted remote control signal 401. The device may process the image to determine boundaries which define the body of the user or identify body parts of the user using a body part recognition function. The captured image may be processed to examine whether the remote control signal 401 is connected to a user by a body part or appendage such as an arm and a hand. In the example shown in FIG. 4c, the first user 402 is holding the remote control in his right hand when the signal 401 is transmitted. By analyzing the arm and determining to which body the arm is connected or if an appendage connection is present, the user in control of the remote at the time of the signal transmission 401 can be ascertained, and the remote control signal 401 may be associated with the first user 402.

While FIG. 4c shows a schematic 2D captured image, the analysis of which user is physically linked or holding a remote control device may be done using a captured 3D image or 3D information. The device may process 3D information captured of or collected from the viewing area to determine which body in the room is holding the remote and through facial recognition associate the face of the body with a particular user.

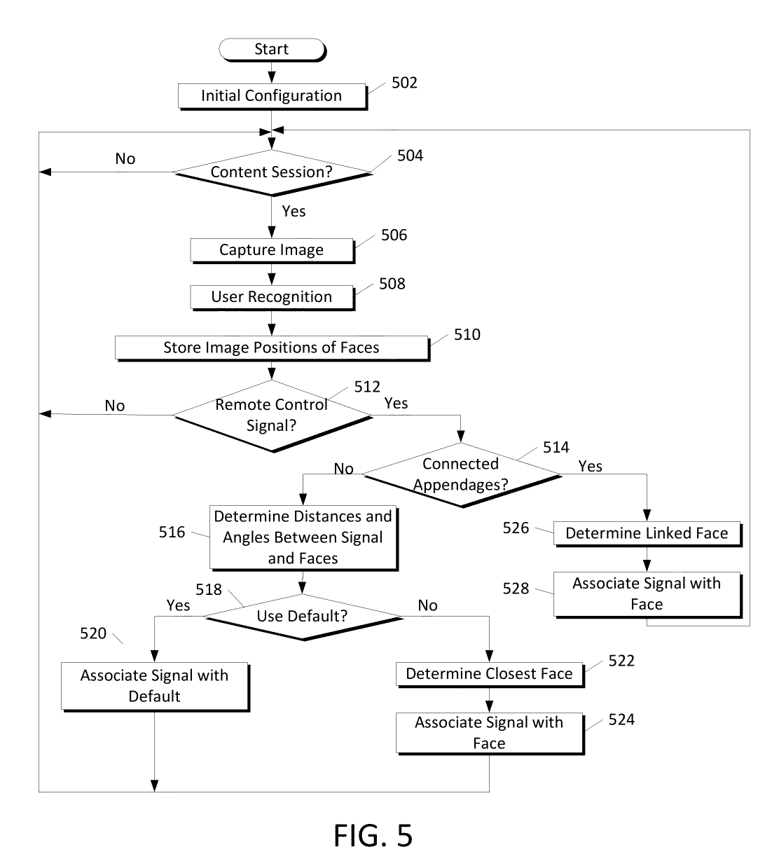

FIG. 5 illustrates a flow chart of an exemplary method of associating an emitted remote control signal with a user 500 based on distances between the remote control signal and the users in a captured image. The method 500 may be implemented in a system or computing device as described herein. At step 502, an initial configuration may be performed such as a calibration of a camera and the remote control or loading of previously saved user profile information and associated data. At step 504, the device can determine whether a content session is currently active or in progress. A content session may occur when the system or computing device is in the process of providing content for a user's consumption, such as displaying a television program for a user to view. If there is presently no active content session, the device may repeat step 504 until the device determines that there is an active content session.

In this example, once there is an active content session, the device can proceed to step 506 and capture an image of the viewing area using an imaging device, which may be part of a content consumption device. FIGS. 3-4c are illustrations of examples of captured images of the viewing area. An imaging device may capture an image or a plurality of images. A plurality of imaging devices may also be used to capture a plurality of images which may be used to compose a captured image for processing. For example, different cameras which are configured to capture light in different electromagnetic spectrums may be used to capture the images. A composed captured image for processing may be formed from a combination of visible light and light outside the visible spectrum such as infrared radiation. One or more imaging devices may be used to capture or collect 3D information of objects within the viewing area to determine the users and their bodies such as portions of their bodies and the remote control device.

In this example, once the viewing area image is captured, the captured image may be analyzed for facial recognition and user location determination at step 508. At step 510, the positions in the image of face(s) of the user(s) may be stored, as well as information identifying the user(s) who is (are) consuming content in the content session. At step 512, the device may determine whether a remote control signal was transmitted at the time the image was captured by determining whether a signal transmission was captured in the image. For example, the image may be processed to determine whether an infrared flash is visible. If no remote control signal was emitted at the time the image was captured, the method returns to step 504.

If a remote control signal transmission was captured in the image, the device can process the captured image to determine whether the captured image shows body portions including appendages or body parts such as an arm or a hand connected to the remote control signal at step 514. This determination may be made by processing a 2D or 3D image to determine body parts or appendages shown in the image.

If there are no appendages connected to the remote control signal, the distances and angles between the signal and the faces may be determined at step 516 as shown in, for example, FIGS. 4a and 4b. The device may evaluate the distance and angles to determine which face or user should be associated with the remote control signal. The device may be configured to use a default criterion, for example, a shortest distance between a body part of the user and the remote control signal in determining which user initiated the remote control signal. At step 518, the device determines whether to use a default, and if a default criterion is selected, the device associates the remote control signal to a user based on the default criterion. Alternatively, at step 522, the device may determine the closest face to the remote control signal based on distance between the face and the remote control signal. The device may also be configured to analyze the angle and the distance between each user and the remote control signal to determine with which user or face to associate the signal at step 524.

If at step 514 the device determines that linked appendages are present in the captured image, the device may determine which face is linked to the remote control signal based on the appendages linked to the remote control signal at step 526. Once a linked face has been determined, the signal is associated with that face or user at step 528.

After steps 520, 522, and 528, the device may return to step 504 to continuously monitor for a content session and/or continuously update the associated user of the remote control signal.

While the image is described as being captured after determining that a content session is active in exemplary method 500, the image may also be captured in response to detecting a remote control signal transmission and then processed based on the originating location of the remote control signal or the location of the remote control. Indeed, the example flow diagrams provided herein are merely examples, and the various steps and components may be rearranged, combined, subdivided and modified as desired for an implementation of the concepts described herein.

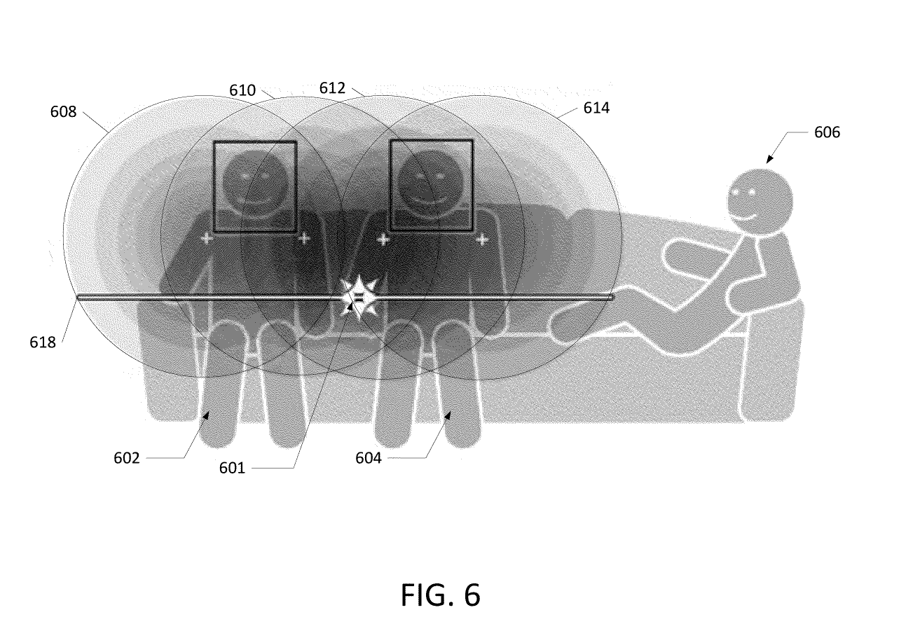

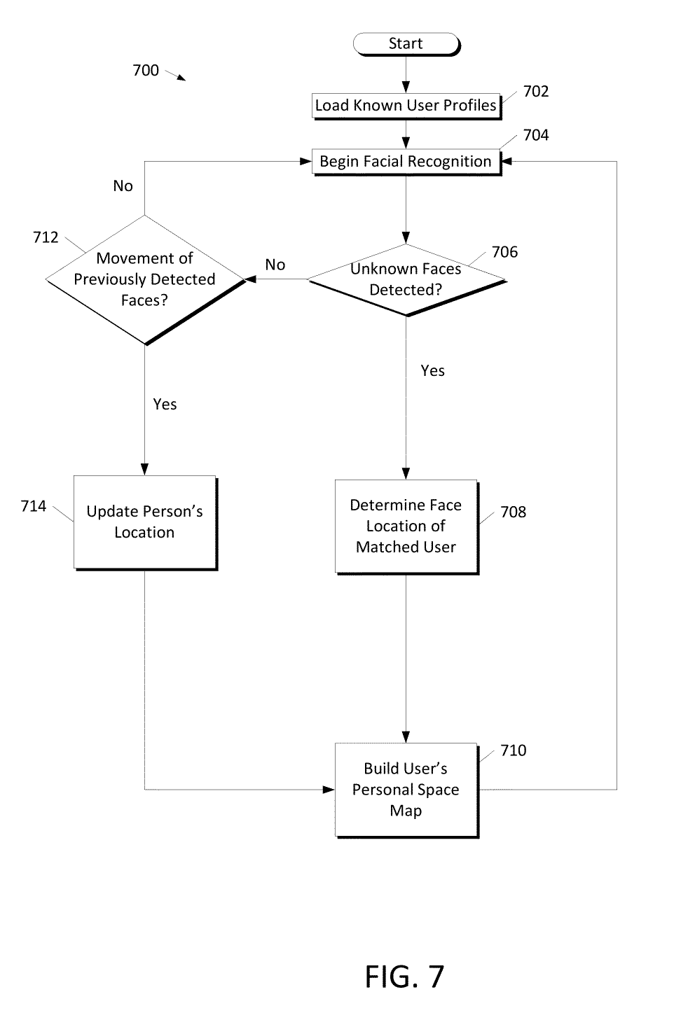

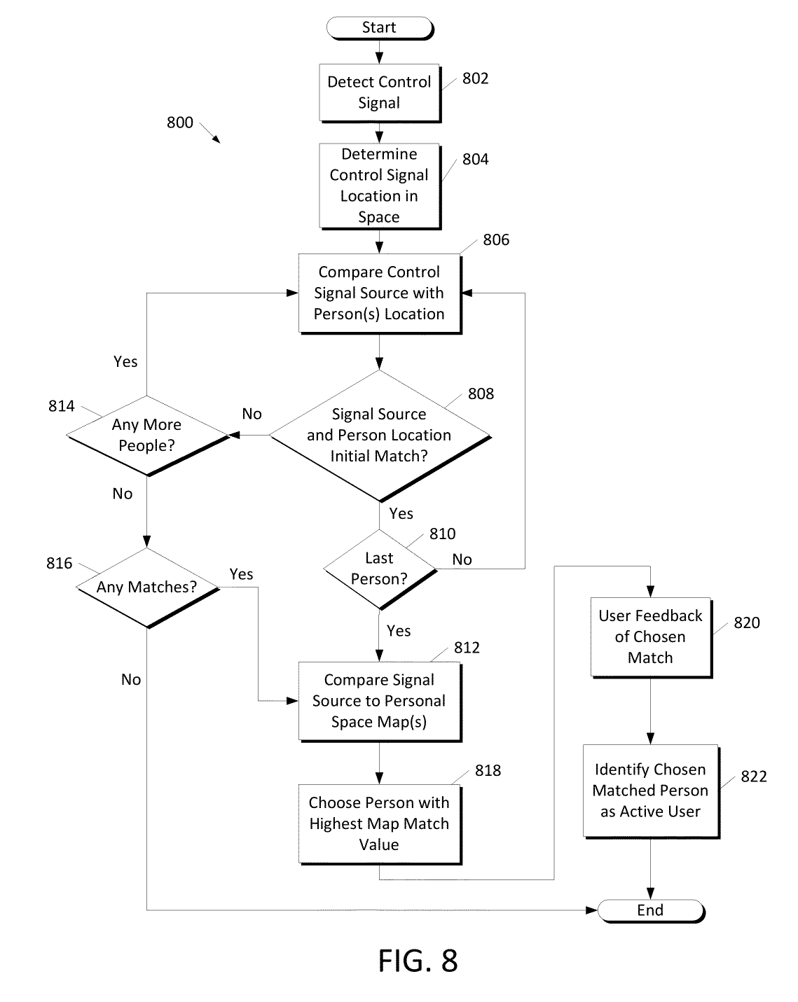

FIG. 6 illustrates another exemplary method of determining where to associate a transmitted remote control signal based on a personal space map of each user which will be described in more detail with respect to the flowchart shown in FIGS. 7 and 8. The captured image shown in FIG. 6 shows a remote control signal 601 and three users 602, 604, 606 within the viewing area overlaid with personal space maps. Personal space maps may represent radial probabilities or confidence values, which originate from a body part of a user, providing information as to whether the remote control signal should be associated with a particular user. Confidence values may be an indication of the strength of a possible association of the remote control signal to a user based on the distance from the user. Personal space maps may be provided in the form of a graphical depiction as shown in FIG. 6 or in the form of a table indicating probability or confidence values with respect to distance from a particular point on a user. A probability or confidence value may be assigned to a radial distance range from a particular point on a user. The image of FIG. 6 shows three users and personal space maps for two of the users. While the captured image shows three users, the device may determine that the third user 606 is sufficiently distanced from the remote control signal 601 that it is unlikely that the third user 606 initiated the remote control signal transmission. For example, if the third user 606 has no body parts or appendages near the location of the remote control signal or if the third user 606 is more than a predetermined distance or threshold distance (e.g. a body length) away from the location of the remote control signal 601, the device may determine that the third user is not the initiator of the remote control signal. Once the third user 606 has been eliminated as a possible remote control signal association, the device may focus on the two users 602, 604 nearer to the remote control signal.

In this example, by performing facial recognition on the captured image, the device can identify users and determine locations of users and their body parts in the image. Based on the location of a user's face, the device can estimate the location of the user's shoulders and construct a personal space map based on the location of each shoulder. FIG. 6 shows a personal space map 608 centered around the right shoulder of the first user 602 and a personal space map 610 centered around the left shoulder of the first user 602. Similarly, second user 602 is provided with personal space maps 612, 614 for each shoulder. As discussed herein, the personal space maps 608, 610, 612, 614 may illustrate the radial probability that a remote control signal may be associated with a particular user or confidence values indicating a strength of the association as a function of distance from the user. Based on the location of the remote control signal within the personal space map 608, the device can determine to which user to associate the remote control signal. The personal space maps shown in FIG. 6 are provided with different shadings to show that regions or radial distance ranges may be assigned different map values. The map value may indicate the probability that a remote control signal 601 is associated with a particular user when originating from that location. A remote control signal 601 located in radial areas closer to the shoulder of a particular user may be more likely to be associated with that particular user.

A personal space map in the form of a table may also be used in combination with or instead of a graphical personal space map. The table may provide a list of distances from a particular point of the user and corresponding probabilities or map values. For example, personal space map 608 divide the distance from the user into distance ranges and provide a corresponding map value or probability for each range.

FIG. 7 shows an example of a method of using facial recognition to build a user's personal space map 700. The method 700 may begin by loading data (e.g., images of faces) or a list of known people or faces at step 702. At step 704, facial recognition may be started and the number of users and associated faces within the viewing area may be detected. The detected faces may also be analyzed to determine whether any of the faces are unknown or not previously analyzed or recognized by comparing the detected faces to those of known people at step 706. If an unknown face is determined, the unknown face is matched to the corresponding unknown person and the detected face location can be determined from that of the matched person at step 708.

At step 710, based on the location of a user's face, the person's personal space map may be constructed. The personal space map may be formed by estimating the location of the person's shoulders using average or estimated face-to-shoulder distances or body proportions. Based on an average body proportions or lengths, the personal space map may be calculated to indicate the probability that the remote control signal is associated with a particular user depending on the radial distance of the remote control signal from a point on the user such as the user's shoulder or confidence values based on the distance between the user and the remote control signal.

Returning to step 706, if there are no new or unknown faces detected, the device may determine whether there is movement or a change in position of the previously detected faces at step 712. If there is no change in position or movement of the previously detected faces, the device can return to the beginning of the facial recognition process at step 704. If there is movement of the previously detected faces, the user's location may be updated at step 714, and the user's personal space map may be updated based on the new location at step 710. The exemplary method 700 may continuously monitor and update locations of users and their personal space maps.

While the personal space map is described as being built based on distance from a shoulder, map values may be calculated based on a variety of factors such as distance from the nearest body part. The personal space map can also have an irregular shape and have increased probabilities in areas near body parts particularly associated with initiating a remote control signal such as a hand or an arm.

FIG. 8 illustrates a flowchart of an example of a method of associating a remote control signal with a user based on the location of the remote control signal in relation to personal space maps of users. At step 802, a control signal can be detected such as a control signal from a remote control, and at step 804, the remote control signal source location in the image may be determined. At step 806, the remote control signal source location may be compared with the location of user(s), and at step 808, the device can determine whether the remote control signal source location matches to the location of a person. For example, the device may compare the signal location to a user's personal space map, and if the location falls within any area of the user's personal space map or within a predetermined distance from the user, the signal location may indicate an initial match with the location of a user. Alternatively, the device may consider the signal location to initially match a user if the signal location is within a predetermined distance from the user. If there is a match, the device may check to determine if there are additional users with which the remote control signal location should be initially compared at step 810. If there are additional users, the method may return to step 806 and compare the remote control signal location with the location of another user. If there no additional users for initial signal location comparison, the method may proceed to step 812.

Returning to step 808, if the remote control signal location does not initially match with that of a particular user, the method may proceed to step 814 and determine whether there are additional users with which to compare the remote control signal location. If there are additional users for initial location comparison, the device may return to step 806 and compare the remote control signal location with that of another user. If at step 814 there are no additional users for initial location comparison, the device may proceed to step 816 where the device determines whether there were any matches in the initial comparisons with users.

If there are no initial matches at step 816, the device may identify or indicate a default user as the active user or use default settings or a default profile. In the event that there is only one initial match, the device may automatically consider that user to be the best personal space map match at step 818. The device may optionally seek user feedback or confirmation of the match at step 820 and identify the user matched at step 818 as the “active” user of the device or system at step 822 in response to positive feedback received in step 820.

If there are more than one initial matches, the signal location is compared with a personal space map(s) of the initially matched user(s) at step 812. If the signal location is initially matched to multiple users, the device may compare the remote control signal location to the personal space map of each user and determine a map match value for each user from this comparison. For example, the higher the map match value of a user the more strongly the map match value may indicate that the remote control signal should be associated with that particular user. At step 818, the device may select the user with the highest map match value as the potential active user. For example, if the signal location is within a predetermined distance from three users or within the personal space map of three users, the device may compare the confidence values of the three users or the personal space maps of the three users. Where larger confidence values indicate a higher degree of confidence that the remote control signal should be associated with a particular user, the device may select the user with the highest or largest confidence value as the best personal map match at step 818. In the event that the confidence values are the same or within a predetermined range of each other, the device may evaluate additional variables or considerations such as the angle or various distances between the user and the remote control signal as discussed herein.

The device may also optionally receive feedback or confirmation from a user about the selection at step 820. For example, the system may display an onscreen message or symbol identifying the user that has been chosen as the one sending the command, and the system may offer the user an option to correct or override the determination (e.g., by pressing a button to respond negatively to the displayed message, and selecting a face from an onscreen display of the captured image as the person in command, or by selecting a user's name from a list). The device may identify the user previously determined to have the highest map match value as the active user at step 822, and process the received remote control command in the context of the selected user's preferences (e.g., pressing a “Favorites” button on the remote control may yield different results depending on who the commanding user was).

For the user feedback at step 820, the user may indicate that the selection by the device of the potential active user is incorrect or undesirable and provide corresponding negative feedback or the user may also confirm or provide positive feedback. For example, the device may display on a display device (e.g., a television or a monitor) the faces identified from the captured image and provide a preliminary indication of which user has been selected by the computing device as the active user. If the user agrees with the device's selection, the user may, for example, confirm the selection by pushing a button on an input device such as an “ENTER” button the remote control. If the device receives negative feedback from the user, the device may return to step 818 and choose the user with the second best map match value as the potential active user. The device may also allow the user to select the active user if the user disagrees with the preliminary selection. The user may, for example, use the input device to move a selection cursor to another face and select the face as the active user. If the user agrees with the selection by the device, the user may provide positive feedback at step 820. In response to the positive feedback, the device may identify the selected user as the active user at step 822.

The method 800 thus determines a user to be the likely source of the remote control signal transmission and associates the remote control signal transmission with the particular user by labeling the user as the “active” user based on a personal space map of a user.

Although example embodiments are described above, the various features and steps may be combined, divided, omitted, rearranged, revised and/or augmented in any desired manner, depending on the specific outcome and/or application. Various alterations, modifications, and improvements will readily occur to those skilled in art. Such alterations, modifications, and improvements as are made obvious by this disclosure are intended to be part of this description though not expressly stated herein, and are intended to be within the spirit and scope of the disclosure. Accordingly, the foregoing description is by way of example only, and not limiting. This patent is limited only as defined in the following claims and equivalents thereto.

1. A method, comprising:
capturing image information of a scene containing a plurality of users and a remote control signal using an imaging device;
determining a location of the remote control signal in the scene based on the captured information;
comparing the location of the remote control signal in the scene with the users based on the captured information; and
determining which of the users initiated the remote control signal.

2. The method of claim 1, wherein the remote control signal is an infrared remote control signal.

3. The method of claim 1, wherein the comparing the location comprises determining distances between the location of the remote control signal and locations of identified body portions of the users.

4. The method of claim 3, wherein the identified body portions of the users comprise faces and at least a hand, arm, shoulder, or neck.

5. The method of claim 1, wherein the comparing the location comprises identifying an appendage connection between the location of the remote control signal and the location of a face of one of the plurality of users.

6. The method of claim 1, wherein the captured image information comprises three-dimensional image information.

7. The method of claim 1, comprising:
identifying a face of each user;
performing facial recognition on the face to identify each user; and
responsive to determining a user initiated the remote control signal, displaying the user's personal preferences.

8. A method, comprising:
processing image information of a scene containing a plurality of users and a signal being transmitted;
comparing a location of the signal in the image with locations of the users; and
determining which of the users initiated the signal.

9. The method of claim 8, wherein the processing the image of the scene containing the plurality of users being transmitted to obtain a location of the signal and locations of the users in the image comprises:
determining the location of the signal in the image;
determining a number of users in the image;
identifying a body part of each user in the image; and
determining a location of the each identified body part in the image.

10. The method of claim 9, wherein the comparing the location of the signal in the image with the locations of the users comprises:
determining a distance between the signal and each identified body part.

11. The method of claim 10, wherein the using results of the comparing to determine which of the users initiated the signal comprises:
identifying the user associated with a smallest distance between the signal and an identified body part as an initiator of the signal.

12. The method of claim 8, wherein the image of the scene is a three-dimensional image.

13. The method of claim 8, comprising:
capturing the image responsive to detecting transmission of the signal.

14. The method of claim 8, wherein the signal is an infrared remote control signal.

15. The method of claim 8, comprising:
performing a recognition function to identify a body part of each user,
wherein the comparing the location of the signal in the image with the locations of the users comprises determining whether an identified body part of a first user connects the first user to the signal,
wherein the using results of the comparing to determine which of the users initiated the signal comprises responsive to determining that the identified body part of the first user connects the first user to the signal, associating the signal with the first user.

16-20. (canceled)

21. A non-transitory computer-readable medium storing computer-executable instructions that when executed cause an apparatus to perform at least the following:
capturing image information of a scene containing a plurality of users and a remote control signal using an imaging device;
determining a location of the remote control signal in the scene based on the captured information;
comparing the location of the remote control signal in the scene with the users based on the captured information; and
determining which of the users initiated the remote control signal.

22. The non-transitory computer-readable medium of claim 21, wherein the comparing the location comprises determining distances between the location of the remote control signal and locations of identified body portions of the users.

23. The non-transitory computer-readable medium of claim 22, wherein the identified body portions of the users comprise faces and at least a hand, arm, shoulder, or neck.

24. The non-transitory computer-readable medium of claim 21, wherein the comparing the location comprises identifying an appendage connection between the location of the remote control signal and the location of a face of one of the plurality of users

25. The non-transitory computer-readable medium of claim 21, wherein the computer-readable medium stores computer-executable instructions that when executed cause an apparatus to perform at least the following:
identifying a face of each user;
performing facial recognition on the face to identify each user; and
responsive to determining a user initiated the remote control signal, displaying the user's personal preferences.
